(19) United States
(12) Patent Application Publication
(10) Pub. No.: US 2025/0108384 A1
(43) Pub. Date: Apr. 3, 2025

(54) JAW CRUSHER AND METHOD OF ADJUSTING GAP WIDTH OF JAW CRUSHER

(71) Applicant: KABUSHIKI KAISHA EARTHTECHNICA, Tokyo (JP)

(72) Inventor: Kenta SAWANO, Tokyo (JP)

(73) Assignee: KABUSHIKI KAISHA EARTHTECHNICA, Tokyo (JP)

(21) Appl. No.: 18/729,025

(22) PCT Filed: Mar. 10, 2022
(86) PCT No.: PCT/JP2022/010657

§ 371 Date: Jul. 15, 2024

(30) Foreign Application Priority Data
Jan. 21, 2022 (JP) 2022-008279

(51) Int. Cl. B02C 1/04

(52) U.S. Cl. CPC B02C 1/04

(57) ABSTRACT

A jaw crusher includes: a fixed jaw plate; a movable jaw plate that swings relative to the fixed jaw plate to crush an object to be crushed between the fixed jaw plate and the movable jaw plate; a gap adjuster including a wedge that adjusts a gap width between the fixed jaw plate and the movable jaw plate; and an actuator that moves the gap adjuster to change the gap width. Preferably, the actuator includes a presser that biases and moves the gap adjuster. The presser is movable to a stand-by position that is away from the gap adjuster.

### TECHNICAL FIELD

The present description discloses a jaw crusher and a method of adjusting a gap width of the jaw crusher.

### BACKGROUND ART

A jaw crusher has been known, which sandwiches and crushes objects to be crushed, such as rock, concrete, and asphalt, by a fixed jaw plate and a movable jaw plate that swings relative to the fixed jaw plate. The particle size of a processed object that has been crushed is adjusted by adjusting a gap width between the fixed jaw plate and the movable jaw plate. There exists a jaw crusher in which the gap width is adjusted by pulling out or inserting a wedge.

According to this jaw crusher, the amount of change of the gap width between the fixed jaw plate and the movable jaw plate is small with respect to a movement distance of the wedge. Therefore, according to this jaw crusher, the gap width can be finely adjusted with a high degree of accuracy. Such jaw crusher is disclosed in PTL 1.

### CITATION LIST

### Patent Literature

PTL 1: Japanese Laid-Open Patent Application Publication No. 2007-253053

### SUMMARY OF INVENTION

### Technical Problem

According to this jaw crusher, the amount of change of the gap width is smaller than the movement distance of the wedge. To change the gap width between the fixed jaw plate and the movable jaw plate, the movement distance of the wedge needs to be increased. When largely changing the gap width, the movement distance of the wedge increases, and the adjustment of the gap width requires labor.

An object of the present applicant is to provide a jaw crusher which can easily adjust a gap width between a fixed jaw plate and a movable jaw plate with a high degree of accuracy.

### Solution to Problem

A preferable jaw crusher includes
a fixed jaw plate;
a movable jaw plate that swings relative to the fixed jaw plate to crush an object to be crushed between the fixed jaw plate and the movable jaw plate;
a gap adjuster including a wedge that adjusts a gap width between the fixed jaw plate and the movable jaw plate; and
an actuator that moves the gap adjuster to change the gap width.

### Advantageous Effects of Invention

This jaw crusher includes the actuator that moves the gap adjuster in such a direction as to change the gap width. Therefore, the jaw crusher can adjust the gap width by the actuator before the adjustment of the gap width by the wedge of the gap adjuster. This jaw crusher can easily adjust the gap width between the fixed jaw plate and the movable jaw plate with a high degree of accuracy.

### BRIEF DESCRIPTION OF DRAWINGS

FIG. 1 is a structure explanatory diagram showing a jaw crusher according to one embodiment.

FIG. 2 is a structure explanatory diagram showing a gap adjuster of the jaw crusher of FIG. 1.

FIG. 3 is a structure explanatory diagram showing a use state in which a fixed jaw plate and movable jaw plate of the jaw crusher of FIG. 1 are in contact with each other.

FIG. 4 is a structure explanatory diagram showing the gap adjuster in the use state shown in FIG. 3.

FIG. 5 is a structure explanatory diagram showing another use state in which a presser that moves the gap adjuster of FIG. 4 is at a stand-by position that is away from the gap adjuster.

FIG. 6 is a structure explanatory diagram showing yet another use state in which a gap width between the fixed jaw plate and the movable jaw plate has been adjusted by the gap adjuster of FIG. 5.

FIG. 7 is a flowchart showing a method of adjusting the gap width by using the jaw crusher of FIG. 1.

FIG. 8 is a structure explanatory diagram showing the gap adjuster of the jaw crusher according to another embodiment.

### DESCRIPTION OF EMBODIMENTS

Hereinafter, preferred embodiments will be described in detail with suitable reference to the drawings.

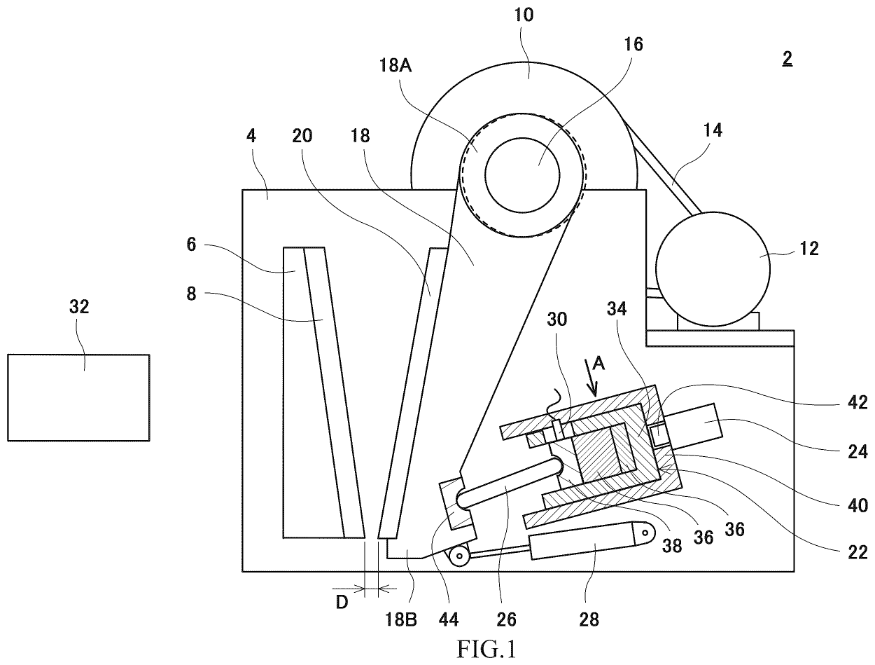

FIG. 1 shows a jaw crusher 2. A left direction of a left-right direction of FIG. 1 corresponds to a front direction of a front-rear direction of the jaw crusher 2. A direction perpendicular to a paper surface of FIG. 1 corresponds to a left-right direction of the jaw crusher 2. The jaw crusher 2 includes a frame 4, a front frame 6, a fixed jaw plate 8, a pulley 10, a motor 12, a belt 14, an eccentric shaft 16, a swing jaw 18, a movable jaw plate 20, a gap adjuster 22, a hydraulic cylinder 24 as an actuator, a toggle plate 26, a tension adjuster 28, a position sensor 30, and control circuitry 32.

The front frame 6 is fixed to the frame 4. The fixed jaw plate 8 is attached to the front frame 6. Thus, the fixed jaw plate 8 is fixed to the frame 4. Although not shown, the fixed jaw plate 8 includes: a main body; a large number of grooves extending along a longitudinal direction of the main body; and a large number of crushing teeth extending in the longitudinal direction of the main body while sandwiching the grooves.

The pulley 10 is rotatably supported by the frame 4. The belt 14 is suspended between the pulley 10 and the motor 12. The eccentric shaft 16 is eccentric to a rotational center of the pulley 10. The eccentric shaft 16 rotatably passes through an upper portion 18A of the swing jaw 18, and the swing jaw 18 is supported by the eccentric shaft 16. Thus, the swing jaw 18 can swing by driving of the motor 12. The movable jaw plate 20 is attached to the swing jaw 18. Although not shown, the movable jaw plate 20 includes: a main body; a large number of grooves extending in a longitudinal direction of the main body; and a large number of crushing teeth extending in the longitudinal direction of the main body while sandwiching the grooves.

The gap adjuster 22 includes a support 34, a pair of wedges 36, and a toggle sheet 38. The gap adjuster 22 is located behind the swing jaw 18. The gap adjuster 22 is located such that the movable jaw plate 20 is located between the fixed jaw plate 8 and the gap adjuster 22. The gap adjuster 22 is supported by a guide 40 included in the frame 4. The gap adjuster 22 is supported by the guide 40 and is movable in a direction toward the fixed jaw plate 8 and a direction away from the fixed jaw plate 8. In FIG. 1, the guide 40 is a guide plate but is not limited to this. For example, the guide 40 may be a guide rail or a combination of a guide rail and a guide plate.

The hydraulic cylinder 24 is supported by the guide 40. The hydraulic cylinder 24 includes a presser 42 that moves the gap adjuster 22. The presser 42 can bias the gap adjuster 22 in the direction toward the fixed jaw plate 8. In FIG. 1, the presser 42 is at a stand-by position that is away from the gap adjuster 22. At this stand-by position, the presser 42 is located, i.e., accommodated in the guide 40 so as not to contact the gap adjuster 22. The presser 42 is attachable to and detachable from a rod of the hydraulic cylinder 24. Or, the rod of the hydraulic cylinder 24 may be used as the presser 42.

The toggle plate 26 is located between the toggle sheet 38 included in the gap adjuster 22 and a toggle sheet 44 included in the swing jaw 18. The tension adjuster 28 is attached to the frame 4. The tension adjuster 28 biases a lower portion 18B of the swing jaw 18 in the direction away from the fixed jaw plate 8. The toggle plate 26 is sandwiched and held between the toggle sheet 38 of the gap adjuster 22 and the toggle sheet 44 of the swing jaw 18 by the biasing of the tension adjuster 28, the weight of the swing jaw 18, and the weight of the movable jaw plate 20.

The position sensor 30 is attached to the frame 4. In this jaw crusher 2, the position sensor 30 is attached to the guide 40 of the frame 4. The position sensor 30 may be attached to such a position as to be able to detect the position of the toggle sheet 38. For example, the position sensor 30 may be attached to a portion of the frame 4 other than the guide 40.

As shown in FIG. 1, in the jaw crusher 2, the fixed jaw plate 8 and the movable jaw plate 20 are located so as to be opposed to each other. An interval between the fixed jaw plate 8 and the movable jaw plate 20 gradually decreases from an upper side to a lower side. This interval does not necessarily have to gradually decrease from the upper side to the lower side. For example, the interval may gradually decrease from an upper side to a lower side and then gradually increase to a further lower side. Arrows D in FIG. 1 indicate a gap width between the fixed jaw plate 8 and the movable jaw plate 20. This gap width D is measured as a minimum distance between the fixed jaw plate 8 and the movable jaw plate 20.

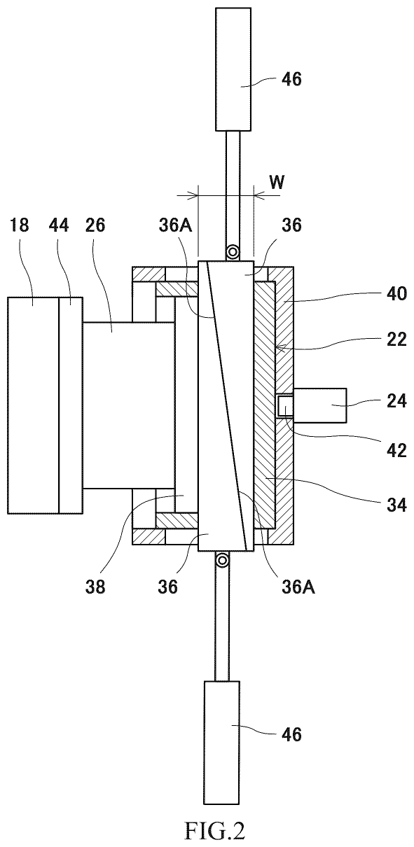

FIG. 2 shows the gap adjuster 22 when viewed in a direction shown by an arrow A in FIG. 1. An upper-lower direction in FIG. 2 corresponds to the left-right direction of the jaw crusher 2. As shown in FIG. 2, the gap adjuster 22 further includes a pair of adjustment cylinders 46 as a pair of wedge adjustment actuators. The adjustment cylinders 46 are not especially limited and are, for example, hydraulic cylinders. The adjustment cylinders 46 are coupled to the respective wedges 36. The wedges 36 include respective tapered surfaces 36A that are inclined relative to an advancing/retreating direction of the gap adjuster 22. The pair of wedges 36 can advance and retreat in the left-right direction by the adjustment cylinders 46 while making the tapered surfaces 36A slide on each other. Arrows W in FIG. 2 indicate a wedge width. Since the gap adjuster 22 includes the support 34, the wedge width W is measured as a width between the toggle sheet 38 and the support 34. In this gap adjuster 22, each of the wedges 36 is located at an advancing end in the left-right direction. The wedge width W is set to a maximum width in the gap adjuster 22.

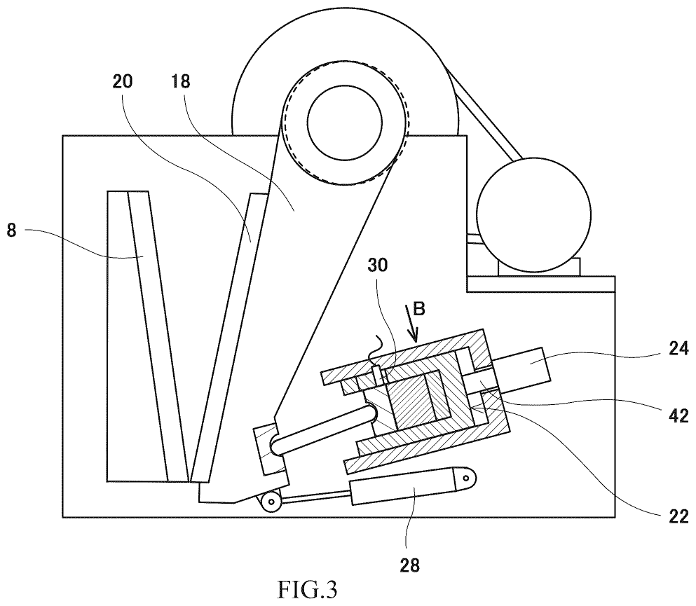

In FIG. 3, the presser 42 of the hydraulic cylinder 24 is in contact with the gap adjuster 22. The gap adjuster 22 is biased by the hydraulic cylinder 24 in the direction toward the fixed jaw plate 8. By this presser 42, the gap adjuster 22 is located closer to the fixed jaw plate 8 than the gap adjuster 22 in the use state shown in FIG. 1. By this gap adjuster 22, the toggle plate 26 and the lower portion 18B of the swing jaw 18 are located closer to the fixed jaw plate 8 than the toggle plate 26 and the lower portion 18B of the swing jaw 18 in the use state shown in FIG. 1. Thus, in FIG. 3, the movable jaw plate 20 is in contact with the fixed jaw plate 8.

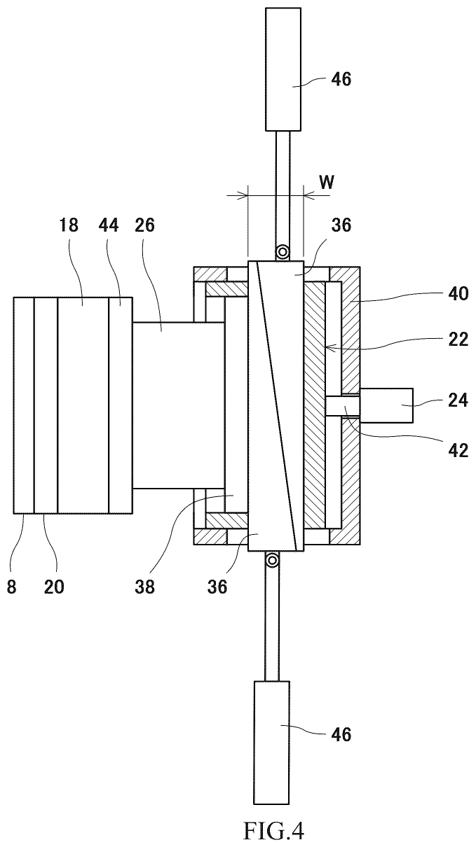

FIG. 4 shows the gap adjuster 22 when viewed in a direction shown by an arrow B in FIG. 3. An upper-lower direction in FIG. 4 corresponds to the left-right direction of the jaw crusher 2. The gap adjuster 22 is being biased by the presser 42 of the hydraulic cylinder 24 in the direction toward the fixed jaw plate 8. The states of the pair of adjustment cylinders 46 and the pair of wedges 36 are the same as those in the use state shown in FIG. 1.

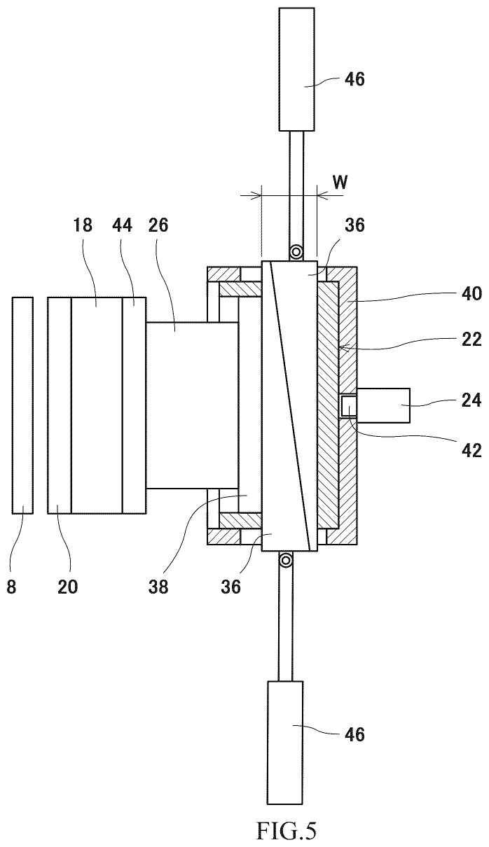

In the use state shown in FIG. 5, the presser 42 of the hydraulic cylinder 24 is located at a position farther from the fixed jaw plate 8 than the presser 42 in the use state shown in FIG. 4. The presser 42 is at the stand-by position that is away from the gap adjuster 22. Other than the above, the use state shown in FIG. 5 is the same as the use state shown in FIG. 4. The gap adjuster 22 is biased in the direction away from the fixed jaw plate 8 and contacts the guide 40 by the biasing of the tension adjuster 28 (see FIG. 3), the weight of the swing jaw 18, and the weight of the movable jaw plate 20.

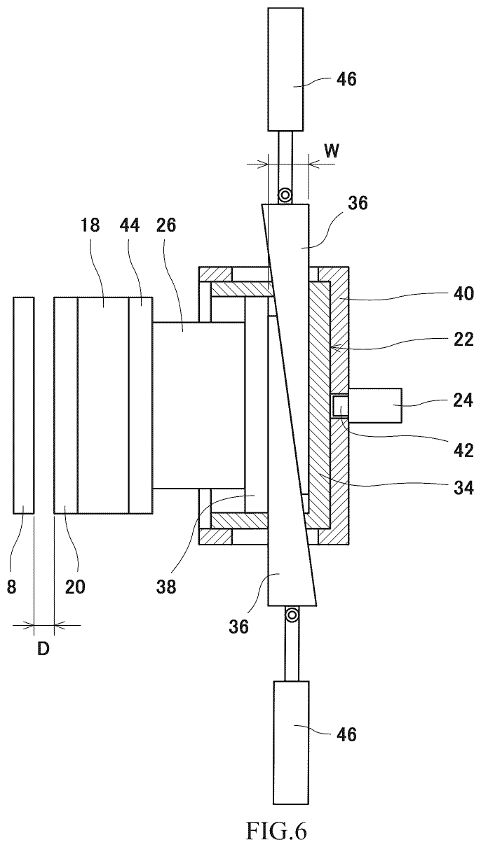

In the use state shown in FIG. 6, the adjustment cylinders 46 make the wedges 36 retreat in the left-right direction from the use state shown in FIG. 5. The wedge width W is smaller than that in the use state shown in FIG. 5. The lower portion 18B of the swing jaw 18 and the toggle plate 26 are located farther from the fixed jaw plate 8 than the lower portion 18B of the swing jaw 18 and the toggle plate 26 in the use state shown in FIG. 5. Thus, the gap width D exists between the fixed jaw plate 8 and the movable jaw plate 20. The gap adjuster 22 can adjust the gap width D between the fixed jaw plate 8 and the movable jaw plate 20 by the wedges 36.

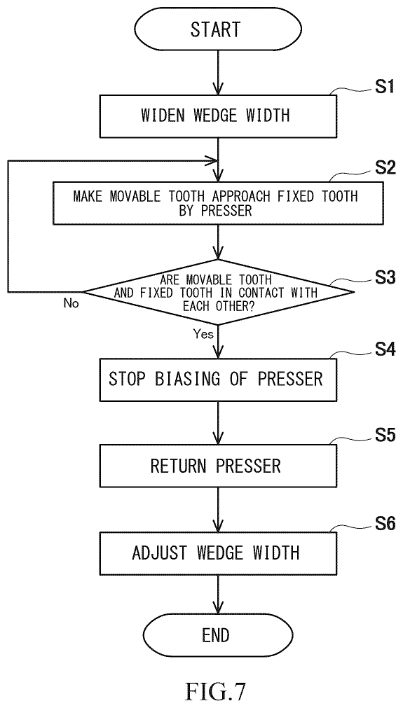

FIG. 7 shows a flowchart of a method of adjusting the gap width D by using this jaw crusher 2. Herein, the method of adjusting the gap width D will be described with reference to FIGS. 1 to 7.

As shown in FIG. 1, in the jaw crusher 2, the presser 42 is normally located at the stand-by position. The control circuitry 32 controls the pair of adjustment cylinders 46 to widen the wedge width W (S1). Herein, the wedge width W is maximized. The jaw crusher 2 is set to the use state shown in FIG. 1.

The control circuitry 32 controls the hydraulic cylinder 24 such that the hydraulic cylinder 24 biases the gap adjuster 22 by the presser 42 in the direction toward the fixed jaw plate 8. The lower portion 18B of the swing jaw 18 is pushed by the gap adjuster 22 and the toggle plate 26 to turn in the direction toward the fixed jaw plate 8. Thus, the movable jaw plate 20 approaches the fixed jaw plate 8 by the presser 42 (S2) and is brought into contact with the fixed jaw plate 8. Thus, the jaw crusher 2 is changed from the use state shown in FIG. 1 to the use state shown in FIG. 3.

In the use state shown in FIG. 3, since the fixed jaw plate 8 and the movable jaw plate 20 are in contact with each other, the gap adjuster 22, the toggle plate 26, and the lower portion 18B of the swing jaw 18 which have moved in the direction toward the fixed jaw plate 8 stop. The position sensor 30 detects the position of the toggle sheet 38. The control circuitry 32 receives a detection signal of the position sensor 30 to detect the stop of the toggle sheet 38. When the toggle sheet 38 stops for a predetermined period of time or more, the control circuitry 32 determines that the fixed jaw plate 8 and the movable jaw plate 20 are in contact with each other (S3). The control circuitry 32 biases the movable jaw plate 20 by the presser 42 in the direction toward the fixed jaw plate 8 until the control circuitry 32 determines that the fixed jaw plate 8 and the movable jaw plate 20 are in contact with each other. The control circuitry 32 also serves as a zero point detector that detects the contact between the fixed jaw plate 8 and the movable jaw plate 20.

In the use state shown in FIG. 3, the gap adjuster 22 and the hydraulic cylinder 24 are in the use state shown in FIG. 4. In this use state, the control circuitry 32 controls the hydraulic cylinder 24 to stop the basing of the presser 42 (S4). The control circuitry 32 controls the hydraulic cylinder 24 to make the hydraulic cylinder 24 return the presser 42 (S5). The presser 42 moves to the stand-by position that is away from the gap adjuster 22. Thus, the hydraulic cylinder 24 is changed from the use state shown in FIG. 4 to the use state shown in FIG. 5.

In the use state shown in FIG. 5, the control circuitry 32 controls the pair of adjustment cylinders 46 to make the wedges 36 retreat in the left-right direction. Thus, the wedge width W decreases from the maximum width. Since the wedge width W decreases, the toggle plate 26 and the lower portion 18B of the swing jaw 18 move in the direction away from the fixed jaw plate 8 by the biasing of the tension adjuster 28 (see FIG. 3), the weight of the swing jaw 18, and the weight of the movable jaw plate 20. The gap width D between the fixed jaw plate 8 and the movable jaw plate 20 is adjusted (S6). Thus, the jaw crusher 2 is changed from the use state shown in FIG. 5 to the use state shown in FIG. 6.

As described above, the position sensor 30 detects the position of the toggle sheet 38. In this jaw crusher 2, the control circuitry 32 may store a setting range of the position of the toggle sheet 38. When the toggle sheet 38 is not within the setting range, the control circuitry 32 may output an alarm that informs of an abnormality. The control circuitry 32 may serve as an alarm generator that informs of an abnormality of the jaw crusher 2.

While this jaw crusher 2 is driving, the gap adjuster 22 that has moved in the direction away from the fixed jaw plate 8 is located at such a retreating end as to contact the guide 40. In this jaw crusher 2, the interval between the fixed jaw plate 8 and the movable jaw plate 20 during the driving can be managed based on the position of the gap adjuster 22 relative to the guide 40 or the frame 4 in the use state shown in FIG. 3 in which the fixed jaw plate 8 and the movable jaw plate 20 are in contact with each other.

The jaw crusher 2 includes the gap adjuster 22 which includes the wedges 36 movable in a direction intersecting with a width direction of the gap width D between the fixed jaw plate 8 and the movable jaw plate 20 and moves the wedges 36 to adjust the gap width D. The amount of change of the gap width D by the gap adjuster 22 relative to the movement distance of the wedges 36 is small. By using the gap adjuster 22, the jaw crusher 2 can finely adjust the gap width D with a high degree of accuracy.

The jaw crusher 2 further includes the hydraulic cylinder 24 that can move the gap adjuster 22 to change the gap width D. The jaw crusher 2 can move the gap adjuster 22 by the hydraulic cylinder 24 to adjust the gap width D. By moving the gap adjuster 22 as above, the jaw crusher 2 can reduce the amount of adjustment of the gap width D by the wedges 36. In the gap adjuster 22, the lengths of the wedges 36 and the strokes of the adjustment cylinders 46 can be reduced. The jaw crusher 2 can adjust the gap width D that is the same in size as a conventional width by using the wedges 36 shorter than conventional wedges and the adjustment cylinders 46 whose strokes are shorter than the strokes of conventional cylinders. The jaw crusher 2 can be reduced in size. The jaw crusher 2 can reduce the labor of the adjustment of the gap width D by the wedges 36.

Moreover, at the time of the driving, i.e., when crushing the objects to be crushed, the wedges 36 of the gap adjuster 22 receive a crushing load. The loads of the adjustment cylinders 46 can be reduced by setting such a friction angle that the tapered surfaces 36A of the wedges 36 do not slip on each other by the crushing load. The wedge 36 including the tapered surface 36A having such friction angle tends to increase in length. However, since the gap adjuster 22 is moved by the hydraulic cylinder 24, the increase in length of the wedge 36 is suppressed.

The hydraulic cylinder 24 includes the presser 42 that biases and moves the gap adjuster 22. The presser 42 can move to the stand-by position that is away from the gap adjuster 22. The presser 42 at the stand-by position is accommodated in the guide 40. According to this jaw crusher 2, at the time of the driving, i.e., when crushing the objects to be crushed, the guide 40 receives the crushing load, but the hydraulic cylinder 24 does not receive the crushing load. Therefore, the damage of the hydraulic cylinder 24 by the crushing load is suppressed. From this point of view, preferably, the presser 42 can move to the stand-by position that is away from the gap adjuster 22. More preferably, at this stand-by position, the presser 42 is accommodated in a structure, such as the guide 40, which supports the hydraulic cylinder 24.

In the jaw crusher 2, the control circuitry 32 serves as the zero point detector that detects the contact between the fixed jaw plate 8 and the movable jaw plate 20. The jaw crusher 2 can use a zero point where the fixed jaw plate 8 and the movable jaw plate 20 contact each other, as a criterion of the adjustment of the gap width D. The jaw crusher 2 can adjust the gap width D without actually measuring the gap width D when adjusting the gap width D. According to the jaw crusher 2, since it is unnecessary to actually measure the gap width D, the gap width D can be remotely adjusted, or the gap width D can be automatically adjusted. In this jaw crusher 2, the control circuitry 32 serves as the zero point detector. However, the zero point detector may be located separately from the control circuitry 32. From this point of view, the jaw crusher 2 preferably includes the zero point detector.

According to this jaw crusher 2, the control circuitry 32 detects the contact between the fixed jaw plate 8 and the movable jaw plate 20 in such a manner that the position sensor 30 detects the position of the toggle sheet 38. On the other hand, for example, the hydraulic pressure of the hydraulic cylinder 24 may be detected, and thus, the contact between the fixed jaw plate 8 and the movable jaw plate 20 may be detected. However, in order to prevent the fixed jaw plate 8 and the movable jaw plate 20 from being damaged, it is preferable to move the presser 42 of the hydraulic cylinder 24 at low speed. The hydraulic pressure of the hydraulic cylinder 24 whose speed is controlled to move the presser 42 at low speed tends to fluctuate. According to this hydraulic cylinder 24, the misdetection of the contact between the fixed jaw plate 8 and the movable jaw plate 20 tends to occur. According to the jaw crusher 2, the control circuitry 32 can suppress the false detection of the contact between the fixed jaw plate 8 and the movable jaw plate 20 in such a manner that the position sensor 30 detects the position of the toggle sheet 38. From this point of view, preferably, the jaw crusher 2 includes the position sensor 30 that detects the position of a detection target.

The position sensor 30 detects the position of the toggle sheet 38. However, the detection target is not limited to this. The detection target may be a detection target which, when the movable jaw plate 20 approaches the fixed jaw plate 8, moves toward the fixed jaw plate 8 together with the movable jaw plate 20. The detection target may be, for example, the movable jaw plate 20, the lower portion 18B of the swing jaw 18, the toggle sheet 44, the toggle plate 26, or part of the gap adjuster 22, such as the support 34.

As described above, it is preferable that the jaw crusher 2 include the position sensor 30. However, the present embodiment is not limited to this. The jaw crusher 2 may detect the hydraulic pressure to detect the contact between the fixed jaw plate 8 and the movable jaw plate 20. For example, when detecting the hydraulic pressure of the hydraulic cylinder 24 to detect the contact between the fixed jaw plate 8 and the movable jaw plate 20, the false detection of the contact between the fixed jaw plate 8 and the movable jaw plate 20 can be suppressed by adjusting a hydraulic circuit, a hydraulic pressure detection position, or a timing.

As described above, the control circuitry 32 may store the setting range of the position of the toggle sheet 38 which is detected by the position sensor 30. The control circuitry 32 may output an alarm when the toggle sheet 38 is not within the setting range. For example, the control circuitry 32 may detect that the toggle sheet 38 is not within the setting range at the zero point where the fixed jaw plate 8 and the movable jaw plate 20 contact each other. Thus, the control circuitry 32 can detect the abrasion of the fixed jaw plate 8 and the movable jaw plate 20. Moreover, the control circuitry 32 can also detect that a foreign matter is caught in the fixed jaw plate 8 or the movable jaw plate 20. The control circuitry 32 may also serve as an alarm generator that detects an abnormal state. The control circuitry 32 includes a function of the alarm generator. The alarm generator may be located separately from the control circuitry 32.

In the method of adjusting the gap width D by using the jaw crusher 2, the control circuitry 32 moves the gap adjuster 22 by the hydraulic cylinder 24 in such a direction as to narrow the gap width D to such a position that the fixed jaw plate 8 and the movable jaw plate 20 contact each other. By using the zero point where the fixed jaw plate 8 and the movable jaw plate 20 contact each other as the criterion, the wedges 36 are moved in such a direction as to widen the gap width D, and thus, the gap width D is set to a predetermined size.

In this method of adjusting the gap width D, the gap width D is adjusted by using the zero point where the fixed jaw plate 8 and the movable jaw plate 20 contact each other as the criterion. Since this method of adjusting the gap width D uses the zero point as the criterion, it is unnecessary to actually measure the gap width D before the adjustment of the gap width D.

By using the zero point as the criterion, the wedges 36 are moved in such a direction as to widen the gap width D, and thus, the gap width D is set to the predetermined size. According to this method of adjusting the gap width D, the gap width D is set to the predetermined size by the wedges 36 by using the zero point as the criterion, and therefore, the gap width D can be finely adjusted with a high degree of accuracy.

According to this method of adjusting the gap width D, before the fixed jaw plate 8 and the movable jaw plate 20 contact each other, the wedge width W is maximized in the gap adjuster 22. Thus, the wedge width W is maximized at the zero point where the fixed jaw plate 8 and the movable jaw plate 20 contact each other. Therefore, an adjustment width of the gap width D by the wedges 36 is maximized. From this point of view, in this method of adjusting the gap width D, preferably, the wedge width W is maximized before the fixed jaw plate 8 and the movable jaw plate 20 contact each other.

According to this method of adjusting the gap width D, the wedge width W of the gap adjuster 22 is maximized, and the control circuitry 32 detects whether or not the toggle sheet 38 is within the setting range. Thus, the control circuitry 32 can easily serve as the alarm generator that informs of the abnormality. From this point of view, when moving the gap adjuster 22, the wedge width W may be a preset width and is not limited to the maximum width.

Herein, the hydraulic cylinder 24 is used as the actuator. However, the actuator is not limited to the hydraulic cylinder 24. The actuator may be able to move the gap adjuster 22. The actuator may be an air cylinder or may be configured such that a ball screw or the like is driven by a motor.

According to this jaw crusher 2, the hydraulic cylinder 24 moves the gap adjuster 22 in the direction toward the fixed jaw plate 8. However, the actuator is not limited to this. The actuator may move the gap adjuster 22 in the direction away from the fixed jaw plate 8. For example, the gap width D between the fixed jaw plate 8 and the movable jaw plate 20 may be measured, and the gap adjuster 22 may be moved in the direction away from the fixed jaw plate 8 to such a position that the gap width D becomes the predetermined gap width D. From the position where the gap width D is the predetermined gap width D, the gap width D may be adjusted by the gap adjuster 22.

The jaw crusher 2 may include a spacer. For example, the jaw crusher 2 may include a spacer sandwiched between the gap adjuster 22 and the presser 42. At the zero point where the fixed jaw plate 8 and the movable jaw plate 20 contact each other, a spacer may be sandwiched between the gap adjuster 22 and the presser 42.

According to this jaw crusher 2, the movable jaw plate 20 is moved by the movement of the gap adjuster 22. However, the present embodiment is not limited to this. In the jaw crusher 2, the fixed jaw plate 8 may be moved by the movement of the gap adjuster 22. In the jaw crusher 2, the fixed jaw plate 8 may be moved by the gap adjuster 22 to adjust the gap width D, and the fixed jaw plate 8 may be moved by the movement of the gap adjuster 22.

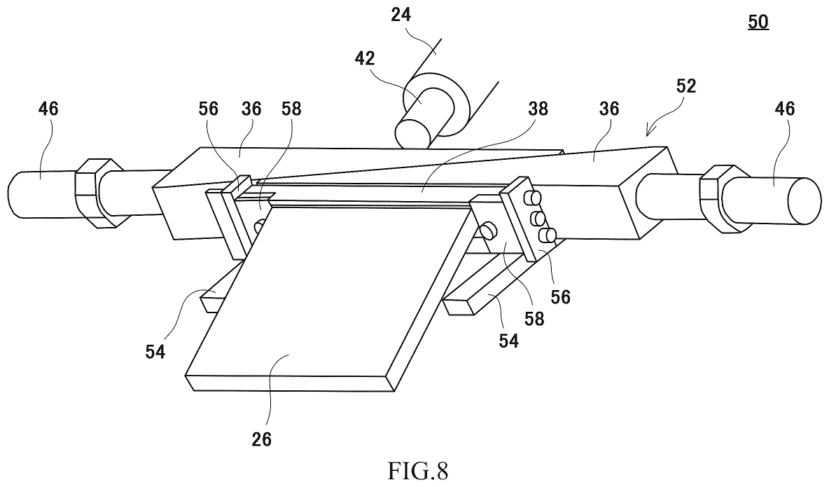

FIG. 8 shows part of a jaw crusher 50 according to another embodiment. In the description of the jaw crusher 50, explanations of the same components as the jaw crusher 2 are omitted, and the same reference signs are used for the same components.

The jaw crusher 50 includes a gap adjuster 52 instead of the gap adjuster 22. The jaw crusher 50 includes a pair of guide rails 54. The gap adjuster 52 is supported by the pair of guide rails 54 and is movable in the direction toward the fixed jaw plate 8 and the direction away from the fixed jaw plate 8. The gap adjuster 52 includes the pair of wedges 36, the toggle sheet 38, a pair of side guides 56, and a pair of stoppers 58. The jaw crusher 50 does not include the support 34 that is included in the jaw crusher 2. The pair of guide rails 54 are supported by a guide included in the frame 4 instead of the guide 40. The other components of the jaw crusher 50 are the same as those of the jaw crusher 2. FIG. 8 shows the pair of guide rails 54 that support the gap adjuster 52 from below. However, another pair of guide rails that sandwich the gap adjuster 52 from above together with the pair of guide rails 54 such that the gap adjuster 52 is movable may be included.

The side guides 56 contact the respective guide rails 54 to prevent the toggle sheet 38 from being displaced in the width direction. The stoppers 58 bring the toggle plate 26 into contact with the toggle sheet 38. Moreover, the stoppers 58 prevent the toggle plate 26 from being displaced in the width direction.

The hydraulic cylinder 24 is supported by the frame 4. At the stand-by position of the presser 42, the presser 42 is located, i.e., accommodated in the frame 4. When the presser 42 biases the gap adjuster 52, the presser 42 directly contacts the wedge 36. As in the jaw crusher 50, the presser 42 may contact the wedge 36. In this gap adjuster 52, the wedge width W is measured as a width of the pair of wedges 36 located between the toggle sheet 38 and the presser 42.

### Disclosed Aspects

The following aspects disclose preferred embodiments.

### First Aspect

A jaw crusher including:
a fixed jaw plate;
a movable jaw plate that swings relative to the fixed jaw plate to crush an object to be crushed between the fixed jaw plate and the movable jaw plate;
a gap adjuster including a wedge that adjusts a gap width between the fixed jaw plate and the movable jaw plate; and
an actuator that moves the gap adjuster to change the gap width.

### Second Aspect

The jaw crusher according to the first aspect, wherein:
the actuator includes a presser that biases and moves the gap adjuster; and
the presser is movable to a stand-by position that is away from the gap adjuster.

### Third Aspect

The jaw crusher according to the first or second aspect, including a zero point detector that detects contact between the fixed jaw plate and the movable jaw plate.

### Fourth Aspect

The jaw crusher according to the third aspect, including a position sensor, wherein
the zero point detector detects the contact between the fixed jaw plate and the movable jaw plate in such a manner that the position sensor detects the position of a detection target.

### Fifth Aspect

The jaw crusher according to the fourth aspect, including an alarm generator informing that the position of the detection target which is detected by the position sensor is outside a setting range.

### Sixth Aspect

A jaw crusher including:
a fixed jaw plate;
a movable jaw plate that swings relative to the fixed jaw plate to crush an object to be crushed between the fixed jaw plate and the movable jaw plate;
a gap adjuster including a wedge that adjusts a gap width between the fixed jaw plate and the movable jaw plate;
an actuator that moves the gap adjuster to change the gap width; and
control circuitry, wherein:
the control circuitry moves the gap adjuster by the actuator to change the gap width; and
the control circuitry adjusts by the wedge the gap width which has been changed by moving the gap adjuster.

### Seventh Aspect

The jaw crusher according to the sixth aspect, wherein:
the actuator moves the gap adjuster to bring the fixed jaw plate and the movable jaw plate into contact with each other; and
based on the position of the gap adjuster when the fixed jaw plate and the movable jaw plate are brought into contact with each other, the gap width is adjusted by the wedge.

### Eighth Aspect

A method of adjusting a gap width, including:
using a gap adjuster including a wedge that adjusts a gap width between a fixed jaw plate and a movable jaw plate that swings relative to the fixed jaw plate to crush an object to be crushed between the fixed jaw plate and the movable jaw plate;
using an actuator that moves the gap adjuster;
moving the gap adjuster by the actuator to change the gap width; and
adjusting by the wedge the gap width which has been changed by moving the gap adjuster.

### Ninth Aspect

The method according to the eighth aspect, including:
moving the gap adjuster by the actuator to bring the fixed jaw plate and the movable jaw plate into contact with each other; and
based on the position of the gap adjuster when the fixed jaw plate and the movable jaw plate are brought into contact with each other, adjusting the gap width by the wedge.

### REFERENCE SIGNS LIST

2, 50 jaw crusher
8 fixed jaw plate
20 movable jaw plate
22, 52 gap adjuster
24 hydraulic cylinder (actuator)
30 position sensor
32 control circuitry (zero point detector, alarm generator)
36 wedge
42 presser
D gap width

1. A jaw crusher comprising:
a fixed jaw plate;
a movable jaw plate that swings relative to the fixed jaw plate to crush an object to be crushed between the fixed jaw plate and the movable jaw plate;
a gap adjuster including a wedge that adjusts a gap width between the fixed jaw plate and the movable jaw plate; and
an actuator that moves the gap adjuster to change the gap width.

2. The jaw crusher according to claim 1, wherein:
the actuator includes a presser that biases and moves the gap adjuster; and
the presser is movable to a stand-by position that is away from the gap adjuster.

3. The jaw crusher according to claim 1, comprising a zero point detector that detects contact between the fixed jaw plate and the movable jaw plate.

4. The jaw crusher according to claim 3, comprising a position sensor, wherein
the zero point detector detects the contact between the fixed jaw plate and the movable jaw plate in such a manner that the position sensor detects the position of a detection target.

5. The jaw crusher according to claim 4, comprising an alarm generator informing that the position of the detection target which is detected by the position sensor is outside a setting range.

6. A jaw crusher comprising:
a fixed jaw plate;
a movable jaw plate that swings relative to the fixed jaw plate to crush an object to be crushed between the fixed jaw plate and the movable jaw plate;
a gap adjuster including a wedge that adjusts a gap width between the fixed jaw plate and the movable jaw plate;
an actuator that moves the gap adjuster to change the gap width; and
control circuitry, wherein:
the control circuitry moves the gap adjuster by the actuator to change the gap width; and
the control circuitry adjusts by the wedge the gap width which has been changed by moving the gap adjuster.

7. The jaw crusher according to claim 6, wherein:
the actuator moves the gap adjuster to bring the fixed jaw plate and the movable jaw plate into contact with each other; and
based on the position of the gap adjuster when the fixed jaw plate and the movable jaw plate are brought into contact with each other, the gap width is adjusted by the wedge.

8. A method of adjusting a gap width, comprising:
using a gap adjuster including a wedge that adjusts a gap width between a fixed jaw plate and a movable jaw plate that swings relative to the fixed jaw plate to crush an object to be crushed between the fixed jaw plate and the movable jaw plate;
using an actuator that moves the gap adjuster;
moving the gap adjuster by the actuator to change the gap width; and
adjusting by the wedge the gap width which has been changed by moving the gap adjuster.

9. The method according to claim 8, comprising:
moving the gap adjuster by the actuator to bring the fixed jaw plate and the movable jaw plate into contact with each other; and
based on the position of the gap adjuster when the fixed jaw plate and the movable jaw plate are brought into contact with each other, adjusting the gap width by the wedge.

10. The jaw crusher according to claim 2, comprising a zero point detector that detects contact between the fixed jaw plate and the movable jaw plate.

11. The jaw crusher according to claim 10, comprising a position sensor, wherein
the zero point detector detects the contact between the fixed jaw plate and the movable jaw plate in such a manner that the position sensor detects the position of a detection target.

12. The jaw crusher according to claim 11, comprising an alarm generator informing that the position of the detection target which is detected by the position sensor is outside a setting range.
